(19) United States
(12) Patent Application Publication
(10) Pub. No.: US 2016/0226802 A1
(43) Pub. Date: Aug. 4, 2016

(54) CORRELATION OF SENT AND RECEIVED ELECTRONIC MESSAGE

(71) Applicant: NOKIA TECHNOLOGIES OY, Espoo (FI)

(72) Inventor: Wei Wang, Beijing (CN)

(21) Appl. No.: 15/021,171

(22) PCT Filed: Sep. 18, 2013
(86) PCT No.: PCT/CN2013/083749

§ 371 Date: Mar. 10, 2016

(51) Int. Cl. H04L 12/58; H04W 4/14

(52) U.S. Cl. CPC H04L 51/08; H04L 51/38; H04W 4/14; H04L 51/10; H04L 51/22

(57) ABSTRACT

Methods for showing a relationship between a sent electronic message and a received electronic message include: (a) sending an outgoing electronic messages from a first user terminal to a second user terminal over a communication network; (b) receiving an incoming electronic message from the second user terminal over the communication network; and (c) correlating the incoming electronic message with a subset of a plurality of outgoing electronic messages to which the incoming electronic message is responsive. Systems for showing such relationships are described.

### TECHNICAL FIELD

The present teachings relate generally to telecommunications and, in some embodiments, to electronic messaging.

### BACKGROUND

Text messaging (a.k.a. texting) refers to a form of communication in which brief electronic messages are exchanged over a communication network between two or more fixed and/or portable devices. Typically, a text message is limited in size to 140 bits, which corresponds to a maximum of 160 English characters or 70 Chinese characters.

Short Message Service (SMS) is a type of text messaging that exchanges text-only messages between fixed landline and/or mobile phone devices. Multimedia Messaging Service (MMS) extends the capability of SMS by allowing the sending of messages that include multimedia content (e.g., videos, pictures, text pages, ringtones, etc.) to and from mobile phones.

The characteristic brevity of text messages, coupled with the fast pace at which text messages typically are composed and sent, can result in miscommunication and/or misunderstanding between users engaged in text messaging conversations. By way of example, if user A sends a first text message to user B and later follows up with a second text message to user B before user B has responded to the first text message, an eventual response from user B is liable to create ambiguity (e.g., user A may be uncertain as to which of the first text message and the second text message user B's response is directed). This potential for ambiguity increases when two or more of user A's text messages to user B each solicits information from user B, and user B's eventual response is terse and lacking in context (e.g., a mere “yes” or “no”).

FIG. 1 depicts an example of a screen 100 on a user A's mobile phone 102. As shown in FIG. 1, user A has two sent messages 104: a first message 51 and a second later message S2. Each of first message 51 and second message S2 asks a questions of a second user B. First message 51 asks “Are you busy now?” and second message S2 asks “Can I call you now?”. As further shown in FIG. 1, user A has so far received only one text message M in response: a terse “yes.” Without further clarification from user B, user A will not know whether the “yes” received from user B is intended as a response to first message S1 or second message S2.

Similar ambiguities may arise in connection with other forms of communication, including but not limited to email. However, at least in the case of email, a response from user B would typically be appended to the prior communication from user A that prompted the response. In such a manner, even in the event of any ambiguity, user A would still typically be able to ascertain the context of user B's response simply by reading one or more prior emails in the appended chain. However, due to the strict size limitations of text messaging, it is not feasible to attach a prior text message to a later response in a manner analogous to emails.

### SUMMARY

The scope of the present invention is defined solely by the appended claims, and is not affected to any degree by the statements within this summary.

By way of introduction, a method in accordance with the present teachings includes: (a) sending, by a processor, an outgoing electronic message from a first user terminal to a second user terminal over a communication network; (b) receiving, by the processor, an incoming electronic message from the second user terminal over the communication network; and (c) correlating, by the processor, the incoming electronic message with a subset of a plurality of outgoing electronic messages to which the incoming electronic message is responsive.

An apparatus in accordance with the present teachings includes at least one processor and at least one memory including computer program code for one or more programs. The at least one memory and the computer program code are configured to, with the at least one processor, cause the apparatus to perform at least the following: (a) send an outgoing electronic message to a remote user terminal over a communication network; (b) receive an incoming electronic message from the remote user terminal over the communication network; and (c) correlate the incoming electronic message with a subset of a plurality of outgoing electronic messages to which the incoming electronic messages is responsive

A non-transitory computer readable storage medium in accordance with the present teachings has stored therein data representing instructions executable by a programmed processor. The storage medium includes instructions for (a) sending an outgoing electronic message to a remote user terminal over a communication network; (b) receiving an incoming electronic message from the remote user terminal over the communication network; and (c) correlating the incoming electronic message with a subset of a plurality of outgoing electronic messages to which the incoming electronic message is responsive.

### BRIEF DESCRIPTION OF THE DRAWINGS

FIG. 1 shows an example of a text messaging conversation on an interface of a mobile phone.

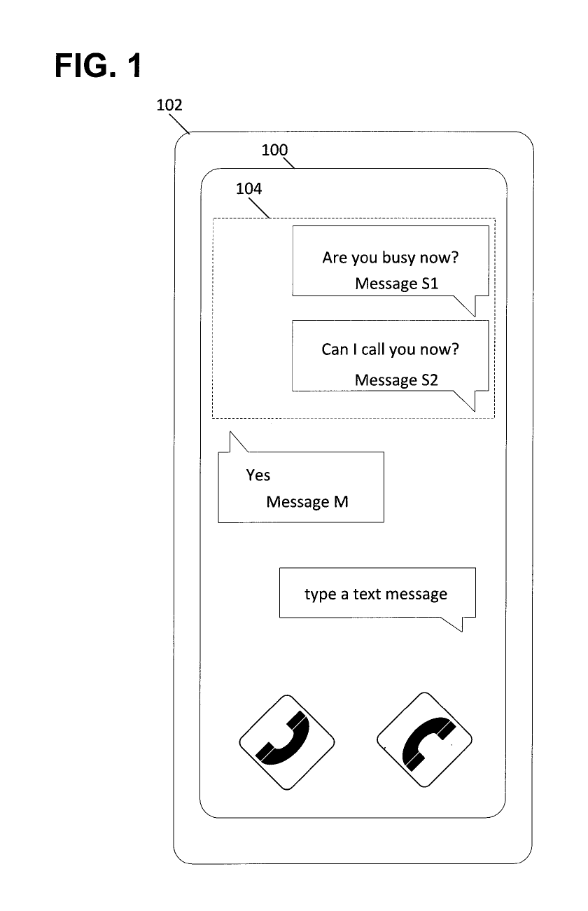

FIG. 2A shows an exemplary flow chart of a representative process in accordance with the present teachings for showing a relationship between a sent electronic message and a received electronic message in a text messaging conversation.

FIG. 2B shows an exemplary flow chart of a representative first embodiment for correlating an incoming electronic message with a subset of a plurality of outgoing electronic messages in accordance with the present teachings.

FIG. 2C shows an exemplary flow chart of a representative second embodiment for correlating an incoming electronic message with a subset of a plurality of outgoing electronic messages in accordance with the present teachings.

FIG. 2D shows an exemplary flow chart of a representative third embodiment for correlating an incoming electronic message with a subset of a plurality of outgoing electronic messages in accordance with the present teachings.

FIG. 3 shows a schematic illustration of an exemplary hash function.

FIG. 4 shows an exemplary SMS conversation tracked in accordance with a first embodiment of the present teachings as seen on a mobile phone of a user A.

FIG. 5 shows the SMS conversation of FIG. 4 as seen on a mobile phone of a user B engaged in conversation with user A.

FIG. 6 shows an exemplary SMS conversation tracked in accordance with a second embodiment of the present teachings as seen on a mobile phone of a user A.

FIG. 7 shows the SMS conversation of FIG. 6 as seen on a mobile phone of a user B engaged in conversation with user A.

FIG. 8 shows a block diagram of a representative apparatus 800 in accordance with the present teachings for showing a relationship between a sent electronic message and a received electronic message in a text messaging conversation.

FIG. 9 shows a representative general computer system 900 for use with a system in accordance with the present teachings.

### DETAILED DESCRIPTION

Methods and apparatuses for correlating incoming and outgoing electronic messages (e.g., SMS messages, etc.) in a text messaging conversation between two or more users have been discovered and are described herein. In some embodiments, a relationship between a sent electronic message and a received electronic message responsive to the sent electronic message is depicted graphically on an interface of a user's mobile phone. By being apprised of the relationship between one or a plurality of sent messages and one or a plurality of received messages within a particular conversation, a user will be better poised to contextualize and understand a received message, and better able to track the conversation.

It is to be understood that elements and features of the various representative embodiments described below may be combined in different ways to produce new embodiments that likewise fall within the scope of the present teachings.

By way of general introduction, a method in accordance with the present teachings for showing a relationship between a sent electronic message and a received electronic message in a text messaging conversation includes: (a) sending an outgoing electronic message from a first user terminal to a second user terminal over a communication network; (b) receiving an incoming electronic message from the second user terminal over the communication network; and (c) correlating the incoming electronic message with a subset of a plurality of outgoing electronic messages to which the incoming electronic message is responsive.

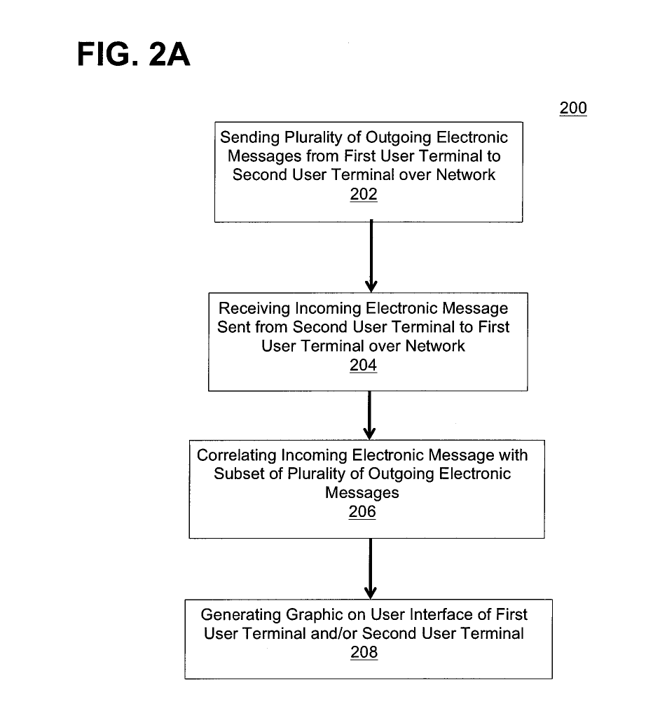

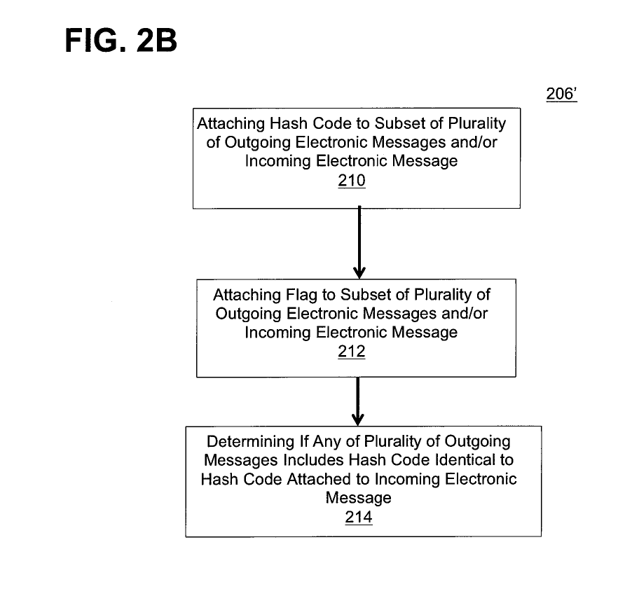

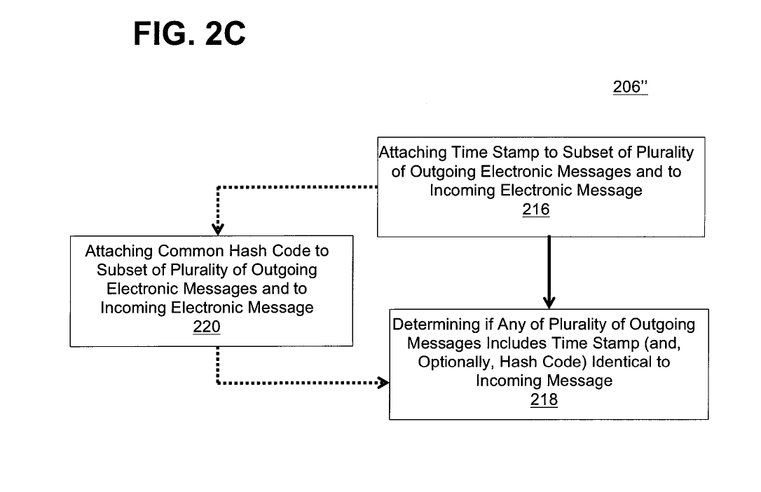

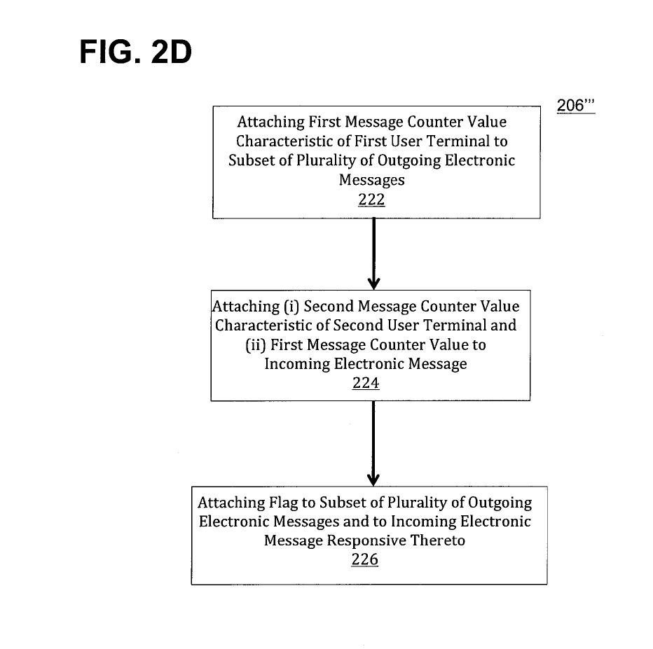

FIG. 2A shows an overview of a representative method 200 in accordance with the present teachings. The method 200 for showing a relationship between a sent electronic message and a received electronic message in a text messaging conversation includes: (a) sending 202 a plurality of outgoing electronic messages from a first user terminal to a second user terminal over a communication network; (b) receiving 204 an incoming electronic message sent from the second user terminal to the first user terminal over the communication network, wherein the incoming electronic message is responsive to a subset of the plurality of outgoing electronic messages; and (c) correlating 206 the incoming electronic message with the subset of the plurality of outgoing electronic messages to which the incoming electronic message is responsive.

In some embodiments, as further shown in FIG. 2A, a method in accordance with the present teachings further includes (d) generating 208 a graphic on a user interface of the first user terminal and/or the second user terminal, wherein the graphic is indicative of a relationship between the incoming electronic message and the subset of the plurality of outgoing electronic messages. All manner of graphics capable of providing a visual indication of a relationship between two or more electronic messages are contemplated for use in accordance with the present teachings. Representative graphic elements and techniques include but are not limited to correlations based on color scheme (e.g., related messages may be shown in the same color, which may be a dedicated color reserved only for depictions of correlated messages), using graphical symbols to identify relationships (e.g., single-head arrows, double-headed arrows, connecting lines, asterisks, and the like, and combinations thereof), altering font characteristics to distinguish correlated messages from uncorrelated ones (e.g., changing font, font style, font point size, and the like, and combinations thereof; showing related messages in boldface while greying out unrelated messages; etc.), and the like, and combinations thereof.

In some embodiments, the incoming electronic message received from the second user terminal is responsive to at least a subset of the plurality of outgoing electronic messages. In other words, in some embodiments, the incoming electronic message may be responsive to more than a subset of the outgoing electronic message in the plurality (viz., the entire set of messages in the plurality). In other embodiments, the incoming electronic message is responsive to only a subset of the plurality of outgoing electronic messages. In some embodiments, the subset of the plurality of outgoing electronic messages includes only a single message in the plurality of messages. In other embodiments, the subset includes two or more but less than all of the messages in the plurality.

In accordance with the present teachings, all manner of user terminals configured for facilitating communication between two or more entities—including fixed devices (e.g., landlines and the like), portable devices (e.g., mobile phones, portable media players, etc.), and combinations thereof—are contemplated for use. By way of example, in some embodiments, each of the first user terminal and the second user terminal is independently selected from the group consisting of mobile phones, landlines, personal computers, game consoles, laptops, notebooks, tablets, portable media players, personal digital assistants, pagers, and the like, and combinations thereof. In some embodiments, one or both of the first user terminal and the second user terminal includes a mobile phone.

The type of sent and received electronic messages to be correlated in accordance with the present teachings is not restricted to a single kind of electronic message and includes all manner of types of electronic messages and combinations of types of electronic messages capable of forming a relationship within the context of an electronic conversation. In some embodiments, each of the plurality of outgoing electronic messages and the incoming electronic message is independently selected from the group consisting of Short Message Service (SMS) messages, Multimedia Messaging Service (MMS) messages, and combinations thereof. In other embodiments, each of the plurality of outgoing electronic messages and the incoming electronic message includes an SMS message. In further embodiments, each of the plurality of outgoing electronic messages and the incoming electronic message includes an MMS message.

All manner of communication networks are contemplated for use in accordance with the present teachings, including but not limited to wired networks (e.g., landlines), wireless networks (e.g., cellular networks), the Internet, and the like, and combinations thereof. In some embodiments, representative communication networks for use in accordance with the present teachings include but are not limited to telecommunication networks, wireless networks, public switched telephone networks (PSTNs), private branch exchanges (PBXs), and the like, and combinations thereof.

In some embodiments, a functionality for showing a relationship between a sent electronic message and a received electronic message in a text messaging conversation is provided as a standard and/or automatically enabled feature of a user terminal. In other embodiments, the functionality is user configurable, such that a user may toggle between “on” and “off” states of the feature if and/or as desired.

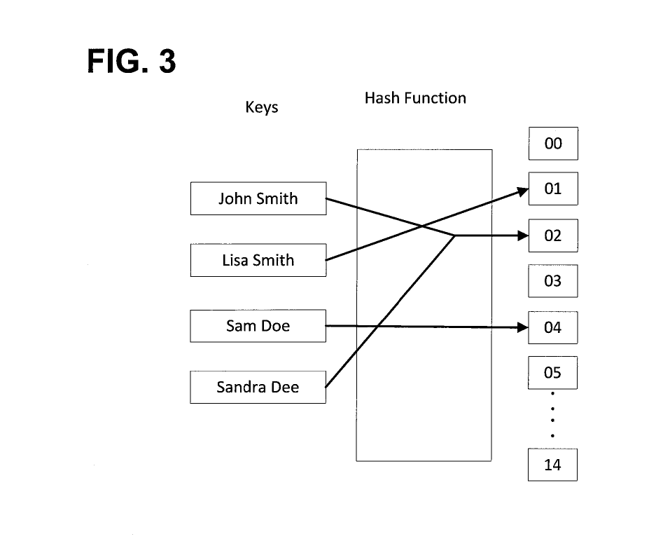

The act of correlating 206 an incoming electronic message with a subset of a plurality of outgoing electronic messages to which the incoming electronic message is responsive may be implemented in a variety of ways. FIG. 2B shows an overview of a first embodiment for implementing correlation in accordance with the present teachings. As shown in FIG. 2B, in some embodiments, the correlating 206′ may include attaching 210 a hash code to the subset of the plurality of outgoing electronic messages and/or to the incoming electronic message responsive thereto. A hash function is any algorithm or subroutine that maps data sets of variable length to data sets of a fixed length. For example, as shown in FIG. 3, names of individuals, which vary in length, may be hashed to a single integer of bounded size. The values returned by a hash function are called hash values or hash codes.

As further shown in FIG. 2B, in some embodiments, the correlating 206′ may further include attaching 212 a flag to the subset of the plurality of outgoing electronic messages and/or to the incoming electronic message responsive thereto. The flag is configured to signify to the first user terminal and/or the second user terminal that a hash code is present and, in some embodiments, the flag includes one or a plurality of invalid characters that are not configured for display on a user interface of either the first user terminal and/or the second user terminal (e.g., invalid Unicode, two invalid ASCII, and the like, and combinations thereof).

In some embodiments, the hash code attached in the act 210 represents a common (e.g., shared) hash code that is attached to the subset of the plurality of outgoing electronic messages as well as to the incoming electronic message responsive thereto. In some embodiments, the act 212 of attaching a flag as shown in FIG. 2B includes attaching a flag to both the subset of the plurality of outgoing electronic messages as well as to the incoming electronic message responsive thereto. The flag signifies that a hash code is present.

In some embodiments, as further shown by FIG. 2B, a method in accordance with the present teachings further includes determining 214 whether any of the plurality of outgoing messages includes a hash code that is identical to a hash code attached to the incoming electronic message.

An example of a representative implementation of the above-described first embodiment of an act of correlating 206′ as shown in FIG. 2B will now be described. By way of background, in a typical SMS sending process, if a user A wants to send a text message to user B, user A's phone (hereafter phone A) first sends the message to a Mobile Switch Center (MSC), which is a subsystem in an operator network system. The MSC detects whether user B's phone (hereafter phone B) is ready to receive a message and, if so, sends the message. If the message is successfully received, phone B sends a message receiving report to the MSC reporting on the success. After the report from phone B is received, the MSC will send a sending report to phone A (provided phone A requested a report).

In accordance with the above-described first embodiment for implementing correlation in accordance with the present teachings, hash codes may be used to identify different messages in a conversation since the hash codes are short sets of fixed-length data and are suitable for use within the size limitations of text messaging. In some embodiments, the hash code of a message from user A that is to be answered by user B can be attached (e.g., at the end) of the new message user B sends. When user A receives the message from user B, all messages in the conversation between the sender and the receiver may be checked and a determination made as to whether there are any messages (e.g., sent messages) having a hash code that is the same as the hash code attached to the received message. In the rare event that several messages in a conversation have the same hash code, the most recently received message is selected.

In further accordance with the above-described first embodiment for implementing correlation in accordance with the present teachings, a flag is attached to sent and/or received messages to indicate that a hash code is present in a message, and that the hash code-containing message may be processed differently than a standard text message. In some embodiments, the flag is attached at the end of a text message. In some embodiments, the size of the flag is 2 bytes and, in other embodiments, 4 bytes. In some embodiments, the flag is set to an invalid Unicode or two invalid ASCII, which cannot be displayed on the screen of a user's phone. Thus, if the phone detects the invalid characters, it will recognize that a hash code is attached (e.g., after the flag).

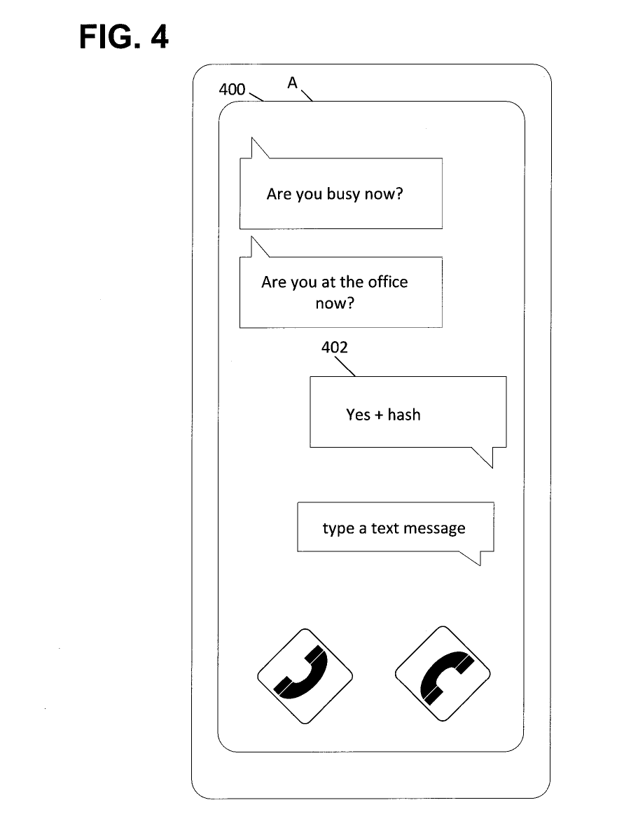

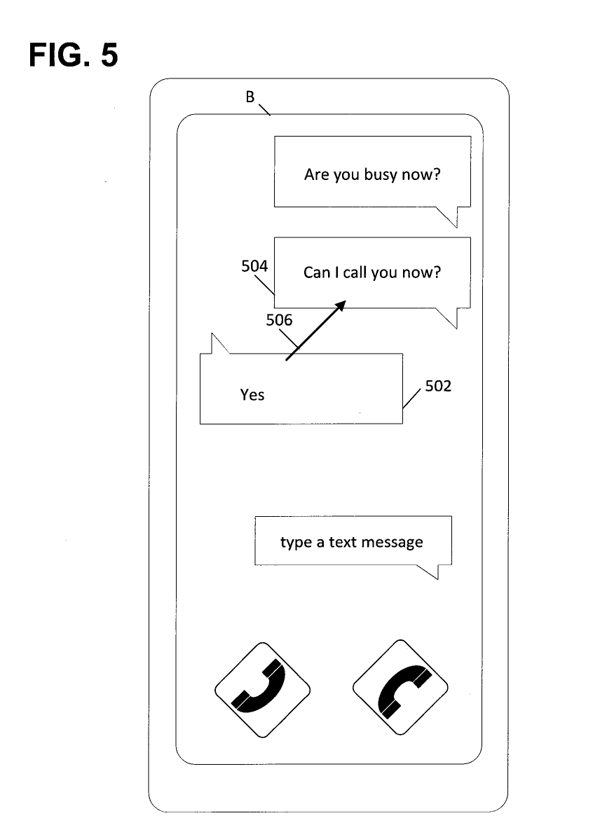

As a representative and non-limiting example in accordance with a first embodiment of the present teachings, FIG. 4 shows an exemplary SMS conversation as seen on a screen 400 of a mobile phone of a user A. As shown in FIG. 4, an incoming electronic message 402 received from a user B includes a hash code at the end of the message. FIG. 5 shows the SMS conversation of FIG. 4 as seen on a screen 500 of a mobile phone of user B engaged in conversation with user A. As shown in FIG. 5, a relationship between a reply 502—which corresponds to the message 402 as seen on the screen 400 of FIG. 4—and a message 504 that instigated reply 502 is depicted with a graphic element 506 (e.g., an arrow).

Message capacity may be slightly reduced through the addition of hash codes and flags. In some embodiments, a hash code has a size of 4 bytes, and a flag to signify to the presence of the hash code has a size of 2 bytes. Thus, in some embodiments, a total of 6 bytes is designated for the act of correlating 206′ an incoming electronic message with a subset of a plurality of outgoing electronic messages to which the incoming electronic message is responsive. Since the capacity of a text message is typically 140 bytes, which corresponds to a maximum of 160 English characters or 70 Chinese characters, the addition of a hash code and flag to a message reduces this capacity slightly to a maximum of 153 English characters or 67 Chinese characters. Thus, message capacity is reduced by only 4.28% (3 out of 70) in the case of Chinese characters, and by only 4.38% (7 out of 160) in the case of English characters.

As explained above, the act of correlating 206 an incoming electronic message with a subset of a plurality of outgoing electronic messages to which the incoming electronic message is responsive may be implemented in a variety of ways. FIG. 2C shows an overview of a second embodiment for implementing correlation in accordance with the present teachings. As shown in FIG. 2C, in some embodiments, the act of correlating 206″ may include attaching 216 a time stamp to the subset of the plurality of outgoing electronic messages, and attaching the same time stamp to the incoming electronic message responsive thereto. In some embodiments, as further shown by FIG. 2C, a method in accordance with the present teachings further includes determining 218 whether any of the plurality of outgoing messages includes a time stamp that is identical to a time stamp attached to the incoming electronic message.

In a variation of the above-described second embodiment, the act of correlating 206 may optionally further include attaching 220 a common hash code to the subset of the plurality of outgoing electronic messages and to the incoming electronic message responsive thereto. In such a variation, a method in accordance with the present teachings further includes determining whether any of the plurality of outgoing messages includes both a time stamp and a hash code that are identical, respectively, to a time stamp and a hash code attached to the incoming electronic message.

An example of a representative implementation of the above-described second embodiment of an act of correlating 206″ as shown in FIG. 2C will now be described. By way of background, in a typical SMS sending process as described above, whereby user A sends a text message M1 to user B via the intermediacy of the MSC, the MSC—upon receipt of text message M1—will record the current time as the sending time (T1). When the MSC then sends user A's message M1 to user B, the MSC attaches T1 to the message sending data, such that the message sending data contains the main text of message M1, the receiver's number, T1, and/or the like. Upon receipt of user A's message, phone B sends a report to the MSC that records the current time as the receiving time (T2). The MSC then sends a report containing both T1 and T2 to phone A indicating that user A's message was successfully sent to phone B.

In accordance with the above-described second embodiment for implementing correlation in accordance with the present teachings, a time stamp may be used to identify different messages in a conversation. In some embodiments, the sending time T1 of a message M1 from user A that is answered by user B can be attached (e.g., at the end) of the new message M2 sent by user B in reply to M1. User A obtains T1 from the sending report and user B obtains T1 when message M1 is received from the MSC. When user B sends message M2 in reply to message M1, sending time T1 is attached to M2 (e.g., at the end). A flag may be used to indicate that a message contains a time stamp in a manner analogous to the description provided above in connection with hash codes. When user A receives the message M2 from user B, all messages in the conversation between the sender and the receiver may be checked and a determination made as to whether there are any messages (e.g., sent messages) having a sending time T1 that is the same as the time stamp attached to the received message M2. Upon determining that M1 has a sending time equal to T1, it may be further determined that M2 is a reply to M1.

The above-described variation of the second embodiment of correlating 206″—whereby a common hash code is optionally attached to the subset of the plurality of outgoing electronic messages and to the incoming electronic message responsive thereto—can be used to avoid a rare event in which several messages in a conversation have the same T1. For example, if two messages have the same T1, the messages may be distinguished using hash codes. If two or more messages have the same T1 as well as identical hash codes, a conclusion may be made that the messages are the same and do not need to be distinguished. In some embodiments, sending time T1 is recorded by an operator system using an operator system clock rather than by the clock of an individual user's phone. Thus, a unique time stamp is assigned to each message in an SMS conversation.

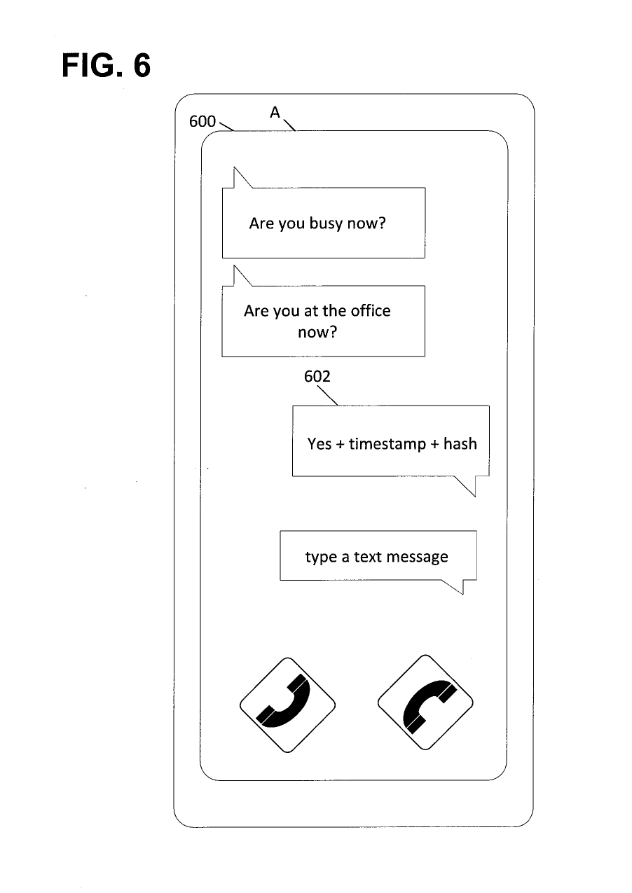

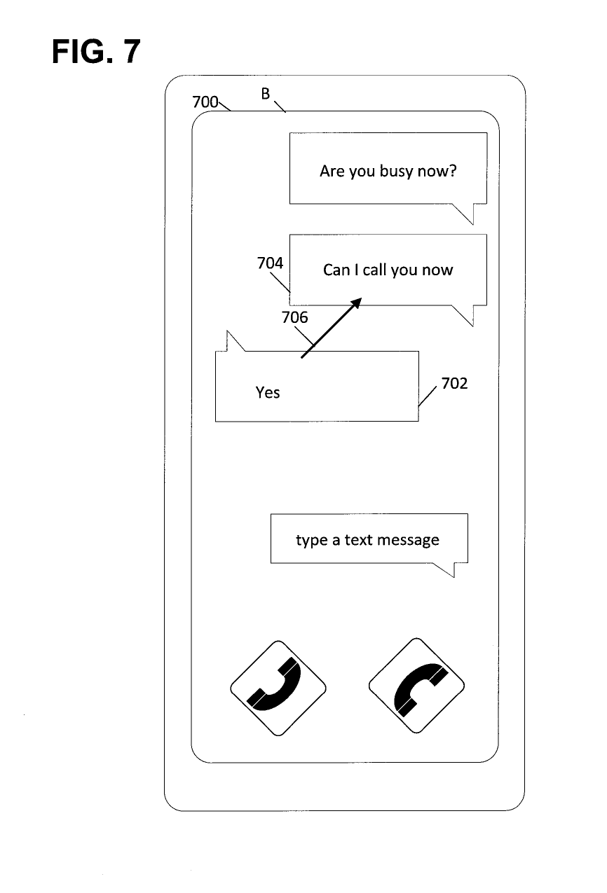

As a representative and non-limiting example in accordance with a second embodiment of the present teachings, FIG. 6 shows an exemplary SMS conversation as seen on a screen 600 of a mobile phone of a user A. As shown in FIG. 6, an incoming electronic message 602 received from a user B includes a time stamp and a hash code at the end of the message. FIG. 7 shows the SMS conversation of FIG. 6 as seen on a screen 700 of a mobile phone of a user B engaged in the conversation with user A. As shown in FIG. 7, a relationship between a reply 702—which corresponds to the message 602 as seen on the mobile phone 600 of FIG. 6—and a message 704 that instigated reply 702 is depicted with a graphic element 706 (e.g., an arrow).

In accordance with the above-described second embodiment of the act of correlating 206″ and its optional variation, message capacity may be slightly reduced through the addition of time stamps and, optionally, hash codes. In some embodiments, a sending time T1 has a size of 4 bytes, and a flag to signify the presence of T1 has a size of 2 bytes. Thus, in some embodiments, a total of 6 bytes is used for the act of correlating 206 an incoming electronic message with a subset of a plurality of outgoing electronic messages to which the incoming electronic message is responsive. If optional hash codes are used as well, message capacity is reduced, in some embodiments, by a total of 11 English characters or 5 Chinese characters.

As explained above, the act of correlating 206 an incoming electronic message with a subset of a plurality of outgoing electronic messages to which the incoming electronic message is responsive may be implemented in a variety of ways. FIG. 2D shows an overview of a third embodiment for implementing correlation in accordance with the present teachings. As shown in FIG. 2D, in some embodiments, the act of correlating 206′″ may include attaching 222 a first message counter value characteristic of the first user terminal to the subset of the plurality of outgoing electronic messages; and attaching 224 to the incoming electronic message each of (i) a second message counter value characteristic of the second user terminal and (ii) the first message counter value attached to the subset of the plurality of outgoing electronic messages to which the incoming electronic message is responsive. In some embodiments, as further shown by FIG. 2D, a method in accordance with the present teachings further includes attaching 226 a flag to the subset of the plurality of outgoing electronic messages and to the incoming electronic message responsive thereto, wherein the flag signifies that a message counter value is present.

An example of a representative implementation of the above-described third embodiment of an act of correlating 206′″ as shown in FIG. 2D will now be described. For example, in some embodiments, a message counter characteristic of a particular device (e.g., a first message counter characteristic of a phone A, a second message counter characteristic of a phone B, etc.) has an initial counter value (e.g., zero) that increases (e.g., by one count) each time the device sends a message. When a device sends a message, it may be configured to add (e.g., to the text of the message) its own counter value and the counter value of the received message to which it is responsive. In some embodiments, the message format is as follows: “message text”+“special flag”+“sender's counter”+“receiver's counter”.

Thus, if phone A has a current counter value of 100, phone B has a current counter value of 200, and user A sends a message M1 to user B that initiates a new conversation, the message counter of phone A increases (e.g., to a value of 101), which is added to the message M1 sent to phone B. In some embodiments, the format of message M1 is as follows: “are you busy now?”+“Oxffff”+“101”+“0”. At this stage in the conversation, the counter value of phone B is represented by zero since phone A is initiating a new conversation and, as of yet, there is no message to which to reply).

If user B sends a reply message M2 to the message M1 received from user A, the format of message M2, in some embodiments, is as follows: “yes”+“Oxffff”+“201”+“101”. If user A sends a reply message M3 to the message M2 received from user B, the format of message M3, in some embodiments, is as follows: “some text”+“Oxffff”+“102”+“201”.

It is to be understood that the relative ordering of some acts shown in the flow charts of FIGS. 2A, 2B, 2C, and 2D is meant to be merely representative rather than limiting, and that alternative sequences may be followed. Moreover, it is likewise to be understood that additional, different, or fewer acts may be provided, and that two or more of these acts may occur sequentially, substantially contemporaneously, and/or in alternative orders.

In some embodiments, the act of correlating 206 an incoming electronic message with a subset of a plurality of outgoing electronic messages to which the incoming electronic message is responsive is implemented via a mechanism that does not rely on whether or not a message sending report functionality (e.g., controlling sending reports sent to and/or received from the MSC) is enabled or disabled. Thus, in some embodiments, the act of correlating 206 involves hash codes as described above in connection with the first embodiment and/or message counter values as described above in connection with the third embodiment.

In some embodiments, a method in accordance with the present teachings for showing a relationship between a sent electronic message and a received electronic message in a text messaging conversation is implemented using a computer and, in some embodiments, one or a plurality of the above-described acts are performed by one or a plurality of processors.

In some embodiments, as described above, the present teachings provide methods for showing a relationship between a sent electronic message and a received electronic message in a text messaging conversation. In other embodiments, as further described below, the present teachings also provide apparatuses for showing such a relationship.

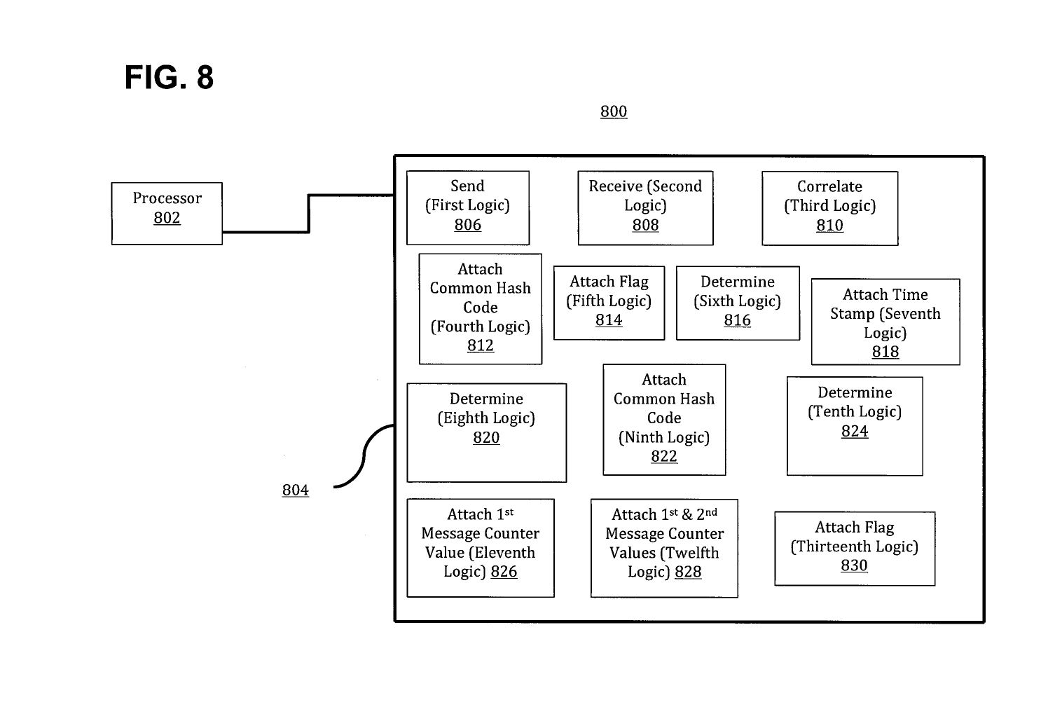

FIG. 8 shows a block diagram of a representative apparatus 800 in accordance with the present teachings for showing a relationship between a sent electronic message and a received electronic message in a text messaging conversation.

In some embodiments, as shown in FIG. 8, an apparatus 800 in accordance with the present teachings is implemented as part of a correlation module in a computer system. As shown in FIG. 8, the apparatus 800 comprises: a processor 802; a non-transitory memory 804 coupled with the processor 802; first logic 806 stored in the non-transitory memory 804 and executable by the processor 802 to cause the apparatus 800 to send a plurality of outgoing electronic messages to a remote user terminal over a communication network; second logic 808 stored in the non-transitory memory 804 and executable by the processor 802 to cause the apparatus 800 to receive an incoming electronic message sent from the remote user terminal over the communication network, wherein the incoming electronic message is responsive to a subset of the plurality of outgoing electronic messages; and third logic 810 stored in the non-transitory memory 804 and executable by the processor 802 to cause the apparatus 800 to correlate the incoming electronic message with the subset of the plurality of outgoing electronic messages to which the incoming electronic message is responsive.

In some embodiments, the apparatus 800 may further include one or more of the following: fourth logic 812 stored in the non-transitory memory 804 and executable by the processor 802 to cause the apparatus 800 to attach a common hash code to the subset of the plurality of outgoing electronic messages and to the incoming electronic message responsive thereto; fifth logic 814 stored in the non-transitory memory 804 and executable by the processor 802 to cause the apparatus 800 to attach a flag to the subset of the plurality of outgoing electronic messages and to the incoming electronic message responsive thereto, wherein the flag signifies that a hash code is present; and/or sixth logic 816 stored in the non-transitory memory 804 and executable by the processor 802 to cause the apparatus 800 to determine whether any of the plurality of outgoing messages includes a hash code that is identical to a hash code attached to the incoming electronic message.

In some embodiments, in addition to or as an alternative to including the above described fourth logic 812, fifth logic 814, and/or sixth logic 816, an apparatus 800 in accordance with the present teachings may further include one or more of the following: seventh logic 818 stored in the non-transitory memory 804 and executable by the processor 802 to cause the apparatus 800 to attach a time stamp to the subset of the plurality of outgoing electronic messages, and attach the same time stamp to the incoming electronic message responsive thereto; eighth logic 820 stored in the non-transitory memory 804 and executable by the processor 802 to cause the apparatus 800 to determine whether any of the plurality of outgoing messages includes a time stamp that is identical to a time stamp attached to the incoming electronic message; ninth logic 822 stored in the non-transitory memory 804 and executable by the processor 802 to cause the apparatus 800 to attach a common hash code to the subset of the plurality of outgoing electronic messages and to the incoming electronic message responsive thereto; and/or tenth logic 824 stored in the non-transitory memory 804 and executable by the processor 802 to cause the apparatus 800 to determine whether any of the plurality of outgoing messages includes both a time stamp and a hash code that are identical, respectively, to a time stamp and a hash code attached to the incoming electronic message.

In some embodiments, in addition to or as an alternative to (a) including the above described fourth logic 812, fifth logic 814, and/or sixth logic 816 and/or (b) including the above described seventh logic 818, eighth logic 820, ninth logic 822, and/or tenth logic 824, an apparatus 800 in accordance with the present teachings may further include one or more of the following: eleventh logic 826 stored in the non-transitory memory 804 and executable by the processor 802 to cause the apparatus 800 to attach a first message counter value characteristic of the first user terminal to the subset of the plurality of outgoing electronic messages; twelfth logic 828 stored in the non-transitory memory 804 and executable by the processor 802 to cause the apparatus 800 to attach to the incoming electronic message each of (i) a second message counter value characteristic of the second user terminal and (ii) the first message counter value attached to the subset of the plurality of outgoing electronic messages to which the incoming electronic message is responsive; and/or thirteenth logic 830 stored in the non-transitory memory 804 and executable by the processor 802 to cause the apparatus 800 to attach a flag to the subset of the plurality of outgoing electronic messages and to the incoming electronic message responsive thereto, wherein the flag signifies that a message counter value is present.

In some embodiments, the apparatus 800 is configured as a device selected from the group consisting of mobile phones, landlines, personal computers, game consoles, laptops, notebooks, tablets, portable media players, personal digital assistants, pagers, and the like, and combinations thereof. In some embodiments, the apparatus 800 is configured as a mobile phone and further includes: (a) user interface circuitry and user interface software configured to (i) facilitate user control of at least some functions of the mobile phone though use of a display and (ii) respond to user inputs; and (b) a display and display circuitry configured to display at least a portion of a user interface of the mobile phone, the display and the display circuitry configured to facilitate user control of at least some of the functions of the mobile phone.

A non-transitory computer-readable storage medium in accordance with the present teachings has stored therein data representing instructions executable by a programmed processor for showing a relationship between a sent electronic message and a received electronic message in a text messaging conversation. The storage medium comprises instructions for: (a) sending a plurality of outgoing electronic messages from a first user terminal to a second user terminal over a communication network; (b) receiving an incoming electronic message sent from the second user terminal to the first user terminal over the communication network, wherein the incoming electronic message is responsive to a subset of the plurality of outgoing electronic messages; and (c) correlating the incoming electronic message with the subset of the plurality of outgoing electronic messages to which the incoming electronic message is responsive.

One skilled in the art will appreciate that one or more modules or logic described herein may be implemented using, among other things, a tangible computer-readable medium comprising computer-executable instructions (e.g., executable software code). Alternatively, modules may be implemented as software code, firmware code, hardware, and/or a combination of the aforementioned.

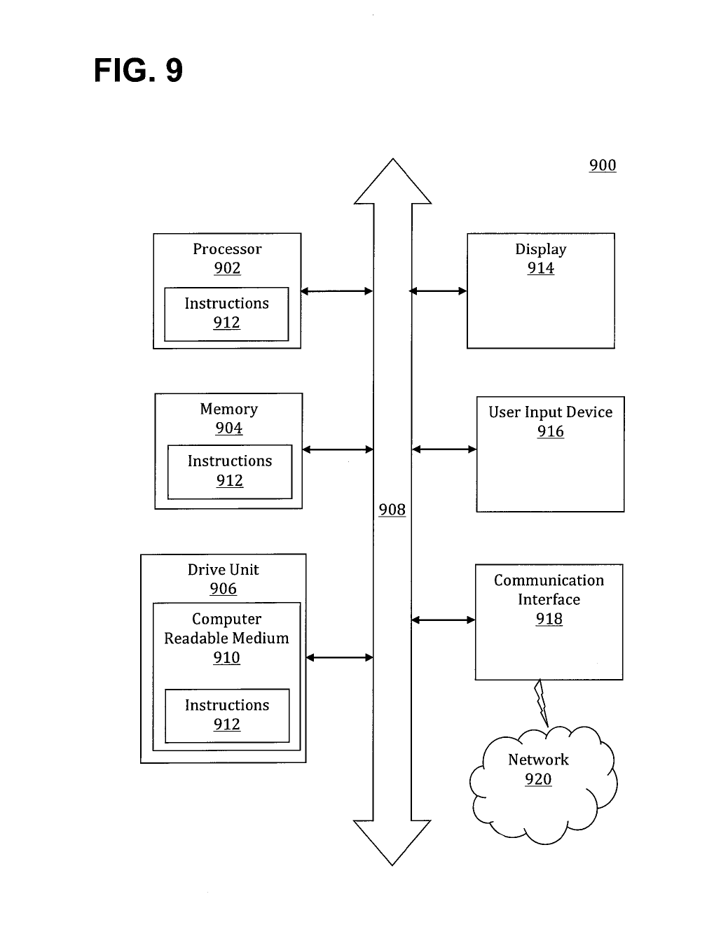

FIG. 9 depicts an illustrative embodiment of a general computer system 900. The computer system 900 can include a set of instructions that can be executed to cause the computer system 900 to perform any one or more of the methods or computer based functions disclosed herein. The computer system 900 may operate as a standalone device or may be connected (e.g., using a network) to other computer systems or peripheral devices. Any of the components discussed above, such as the processor, may be a computer system 900 or a component in the computer system 900. The computer system 900 may implement a correlating engine for showing a relationship between a sent electronic message and a received electronic message in a text messaging conversation, of which the disclosed embodiments are a component thereof.

In a networked deployment, the computer system 900 may operate in the capacity of a server or as a client user computer in a client-server user network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a landline telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In some embodiments, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As shown in FIG. 9, the computer system 900 may include a processor 902, for example a central processing unit (CPU), a graphics-processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some embodiments, the memory 904 includes a cache or random access memory for the processor 902. In alternative embodiments, the memory 904 is separate from the processor 902, such as a cache memory of a processor, the system memory, or other memory. The memory 904 may be an external storage device or database for storing data. Examples include a hard drive, compact disc (CD), digital video disc (DVD), memory card, memory stick, floppy disc, universal serial bus (USB) memory device, or any other device operative to store data. The memory 904 is operable to store instructions executable by the processor 902. The functions, acts or tasks illustrated in the figures or described herein may be performed by the programmed processor 902 executing the instructions 912 stored in the memory 904. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown in FIG. 9, the computer system 900 may further include a display unit 914, such as a liquid crystal display (LCD), an organic light emitting diode (OLED), a flat panel display, a solid state display, a cathode ray tube (CRT), a projector, a printer or other now known or later developed display device for outputting determined information. The display 914 may act as an interface for the user to see the functioning of the processor 902, or specifically as an interface with the software stored in the memory 904 or in the drive unit 906.

Additionally, as shown in FIG. 9, the computer system 900 may include an input device 916 configured to allow a user to interact with any of the components of system 900. The input device 916 may be a number pad, a keyboard, or a cursor control device, such as a mouse, or a joystick, touch screen display, remote control or any other device operative to interact with the system 900.

In some embodiments, as shown in FIG. 9, the computer system 900 may also include a disk or optical drive unit 906. The disk drive unit 906 may include a computer-readable medium 910 in which one or more sets of instructions 912 (e.g., software) can be embedded. Further, the instructions 912 may embody one or more of the methods or logic as described herein. In some embodiments, the instructions 912 may reside completely, or at least partially, within the memory 904 and/or within the processor 902 during execution by the computer system 900. The memory 904 and the processor 902 also may include computer-readable media as described above.

The present teachings contemplate a computer-readable medium that includes instructions 912 or receives and executes instructions 912 responsive to a propagated signal, so that a device connected to a network 920 can communicate voice, video, audio, images or any other data over the network 920. Further, the instructions 912 may be transmitted or received over the network 920 via a communication interface 918. The communication interface 918 may be a part of the processor 902 or may be a separate component. The communication interface 918 may be created in software or may be a physical connection in hardware. The communication interface 918 is configured to connect with a network 920, external media, the display 914, or any other components in system 900, or combinations thereof. The connection with the network 920 may be a physical connection, such as a wired Ethernet connection or may be established wirelessly as discussed below. Likewise, the additional connections with other components of the system 900 may be physical connections or may be established wirelessly.

The network 920 may include wired networks, wireless networks, or combinations thereof. The wireless network may be a cellular telephone network, an 802.11, 802.16, 802.20, or WiMax network. Further, the network 920 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of subject matter described in this specification can be implemented as one or more computer program products, for example, one or more modules of computer program instructions encoded on a computer-readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable medium can be a machine-readable storage device, a machine-readable storage substrate, a memory device, or a combination of one or more of them. The term “data processing apparatus” encompasses all apparatuses, devices, and machines for processing data, including but not limited to, by way of example, a programmable processor, a computer, or multiple processors or computers. The apparatus can include, in addition to hardware, code that creates an execution environment for the computer program in question (e.g., code that constitutes processor firmware, a protocol stack, a database management system, an operating system, or a combination thereof).

In some embodiments, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the present teachings are considered to include any one or more of a computer-readable medium or a distribution medium and other equivalents and successor media, in which data or instructions may be stored.

In some embodiments, dedicated hardware implementations, such as application specific integrated circuits, programmable logic arrays, and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In some embodiments, the methods described herein may be implemented by software programs executable by a computer system. Further, in some embodiments, implementations can include distributed processing, component/object distributed processing, and parallel processing. Alternatively, virtual computer system processing can be constructed to implement one or more of the methods or functionality as described herein.

Although the present teachings describe components and functions that may be implemented in particular embodiments with reference to particular standards and protocols, the present invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform functions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The main elements of a computer are a processor for performing instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a personal digital assistant (PDA), a mobile audio player, a Global Positioning System (GPS) receiver, to name just a few. Computer-readable media suitable for storing computer program instructions and data include all forms of non volatile memory, media and memory devices, including but not limited to, by way of example, semiconductor memory devices (e.g., EPROM, EEPROM, and flash memory devices); magnetic disks (e.g., internal hard disks or removable disks); magneto optical disks; and CD ROM and DVD-ROM disks. The processor and the memory can be supplemented by, or incorporated in, special purpose logic circuitry.

To provide for interaction with a user, some embodiments of subject matter described herein can be implemented on a device having a display, for example a CRT (cathode ray tube) or LCD (liquid crystal display) monitor, for displaying information to the user and a keyboard and a pointing device, for example a mouse or a trackball, by which the user can provide input to the computer. Other kinds of devices can be used to provide for interaction with a user as well. By way of example, feedback provided to the user can be any form of sensory feedback (e.g., visual feedback, auditory feedback, or tactile feedback); and input from the user can be received in any form, including but not limited to acoustic, speech, or tactile input.

Embodiments of subject matter described herein can be implemented in a computing system that includes a back-end component, for example, as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. Examples of communication networks include but are not limited to a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 CFR §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

The foregoing detailed description and the accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

1-25. (canceled)

26. A method comprising:
sending, by a processor, an outgoing electronic message from a first user terminal to a second user terminal over a communication network;
receiving, by the processor, an incoming electronic message from the second user terminal over the communication network; and
correlating, by the processor, the incoming electronic message with a subset of a plurality of outgoing electronic messages to which the incoming electronic message is responsive.

27. The method according to claim 26 further comprising generating, by the processor, a graphic on a user interface of the first user terminal and/or the second user terminal, wherein the graphic is indicative of a relationship between the incoming electronic message and the subset of the plurality of outgoing electronic messages.

28. The method according to claim 26, wherein each of the first user terminal and the second user terminal is independently selected from the group consisting of mobile phones, landlines, personal computers, game consoles, laptops, notebooks, tablets, portable media players, personal digital assistants, pagers, and combinations thereof.

29. The method according to claim 26, wherein one or both of the first user terminal and the second user terminal comprises a mobile phone.

30. The method according to claim 26, wherein each of the plurality of outgoing electronic messages and the incoming electronic message is independently selected from the group consisting of Short Message Service (SMS) messages, Multimedia Messaging Service (MMS) messages, and combinations thereof.

31. The method according to claim 26, wherein each of the plurality of outgoing electronic messages and the incoming electronic message comprises an SMS message.

32. The method according to claim 26, wherein the communication network is selected from the group consisting of a wireless network, a public switched telephone network (PSTN), a private branch exchange (PBX), and combinations thereof.

33. The method according to claim 26, wherein the correlating comprises:
attaching a common hash code to the subset of the plurality of outgoing electronic messages and to the incoming electronic message responsive thereto; and
attaching a flag to the subset of the plurality of outgoing electronic messages and to the incoming electronic message responsive thereto, wherein the flag signifies that a hash code is present.

34. The method according to claim 33 wherein the flag comprises one or a plurality of invalid characters that are not configured for display on a user interface of either the first user terminal or the second user terminal.

35. The method according to claim 26, further comprising determining, by the processor, whether any of the plurality of outgoing messages comprises a hash code that is identical to a hash code attached to the incoming electronic message.

36. The method according to claim 26, wherein the correlating comprises attaching a time stamp to the subset of the plurality of outgoing electronic messages, and attaching the same time stamp to the incoming electronic message responsive thereto.

37. The method according to claim 26, further comprising determining, by the processor, whether any of the plurality of outgoing messages comprises a time stamp that is identical to a time stamp attached to the incoming electronic message.

38. The method according to claim 26, further comprising attaching a common hash code to the subset of the plurality of outgoing electronic messages and to the incoming electronic message responsive thereto.

39. The method according to claim 26, further comprising determining, by the processor, whether any of the plurality of outgoing messages comprises both a time stamp and a hash code that are identical, respectively, to a time stamp and a hash code attached to the incoming electronic message.

40. The method according to claim 26, wherein the correlating comprises:
attaching a first message counter value characteristic of the first user terminal to the subset of the plurality of outgoing electronic messages; and
attaching to the incoming electronic message each of (i) a second message counter value characteristic of the second user terminal and (ii) the first message counter value attached to the subset of the plurality of outgoing electronic messages to which the incoming electronic message is responsive.

41. The method according to claim 40 wherein the correlating further comprises:
attaching a flag to the subset of the plurality of outgoing electronic messages and to the incoming electronic message responsive thereto, wherein the flag signifies that a message counter value is present.

42. An apparatus comprising:
at least one processor; and
at least one memory including computer program code for one or more programs, the at least one memory and the computer program code configured to, with the at least one processor, cause the apparatus to perform at least the following:
send an outgoing electronic message to a remote user terminal over a communication network;
receive an incoming electronic message from the remote user terminal over the communication network; and
correlate the incoming electronic message with a subset of a plurality of outgoing electronic messages to which the incoming electronic message is responsive.

43. The apparatus according to claim 42 wherein the at least one memory and the computer program code are further configured to, with the at least one processor, cause the apparatus to generate a graphic indicative of a relationship between the incoming electronic message and the subset of the plurality of outgoing electronic messages.

44. The apparatus according to claim 42, wherein the at least one memory and the computer program code are further configured to, with the at least one processor, cause the apparatus to perform at least the following:
attach a common hash code to the subset of the plurality of outgoing electronic messages and to the incoming electronic message responsive thereto;
attach a flag to the subset of the plurality of outgoing electronic messages and to the incoming electronic message responsive thereto, wherein the flag signifies that a hash code is present; and
determine whether any of the plurality of outgoing messages comprises a hash code that is identical to a hash code attached to the incoming electronic message.

45. In a non-transitory computer-readable storage medium having stored therein data representing instructions executable by a programmed processor, the storage medium comprising instructions for:
sending an outgoing electronic message to a remote user terminal over a communication network;
receiving an incoming electronic message from the remote user terminal over the communication network; and
correlating the incoming electronic message with a subset of a plurality of outgoing electronic messages to which the incoming electronic message is responsive.
